(19) United States
(12) Patent Application Publication
(10) Pub. No.: US 2002/0141806 A1
(43) Pub. Date: Oct. 3, 2002

(54) PRINTER WITH MULTIPLE SITTING SURFACES

(76) Inventors: TAKESHI ENDO, SUWA-SHI (JP); YUKIHIRO HANAOKA, SUWA-SHI (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 09/457,609

(22) Filed: Dec. 8, 1999

(30) Foreign Application Priority Data
Dec. 8, 1998 (JP) 10-348696

(51) Int. Cl. G01D 15/10

(52) U.S. Cl. 400/693

(57) ABSTRACT

A printer that can be used in a plurality of orientations provides easy connection of external cables to the printer regardless of the position in which the printer is used. The printer housing 11 has a substantially triangular shape in cross-section, three sides of which function as printer sitting surfaces 11b, 11c, and 11d. Roll paper 20 is stored in a roll paper compartment 30 at substantially the printer's center of gravity. A paper exit 12 for the roll paper 20 is located at one of the three vertices C, D, and E of the triangular shape. The location of a printing mechanism unit 31, control unit 32, and power supply unit 33 are distributed among the three vertices C, D, and E.

### BACKGROUND OF THE INVENTION

1. Field of the Invention

The present invention relates to a printer having a plurality of sitting surfaces, thereby enabling the printer to be placed or set down for use in more than one orientation.

2. Description of the Related Art

Typically, printers have one sitting surface, i.e. the bottom, and the printer is placed on this sitting surface for use. As printer applications have increased, demand has grown for a printer that can be installed or placed for use in multiple orientations, thereby enabling a single printer model to be oriented in different ways for specific installation requirements. For example, some users of point-of-sale (POS) printers want the printed paper to exit from the top of the printer while other users want the paper to exit from the bottom. It is therefore desirable to have a single printer that can be installed so that, in this example, the printed paper will exit from either the top or the bottom of the printer, as desired by a particular end user.

However, printer cables such as a power cord and an interface cable for connecting the printer to a host computer or other input/output device must be connected at some physical location in the printer housing. These cables must connect to the printer through some kind of electrical connector exposed to the outside of the printer housing. The location of such connectors limits the flexibility in orientation of the printer for use. More specifically, the connector for electrically connecting the printer to an external device must be located on at least one side of the printer. If the printer is installed or placed so that it rests on the side having the electrical connectors, it is either impossible or very difficult to connect and disconnect the power cord and other cables to the corresponding printer connectors.

Therefore, there is a need for a printer capable of being installed and used in a plurality of orientations while allowing easy access to the electrical and other connectors used for connecting cables, such as a power cord and printer interface cable, to the printer.

There is also strong demand among users of roll paper printers, in which the roll paper supply is internally stored, for a printer with the smallest possible footprint (size).

There is therefore a need for a printer in which the roll paper and other necessary printer components, such as the printing mechanism, controller, and power supply unit, to be efficiently housed inside a housing with an extremely small footprint.

### OBJECTS OF THE INVENTION

Therefore, it is an object of the present invention to overcome the aforementioned problems.

With consideration given to the above-noted problems, it is an object of the present invention to provide a printer housing having a plurality of printer sitting surfaces such that a power cord, printer interface cable, or other cable can be connected to the electrical connectors of the printer regardless of the sitting surface on which the printer is placed for use.

A further object of the present invention is to achieve the above object in a printer in which roll paper is internally stored while at the same time achieving an extremely small footprint.

### SUMMARY OF THE INVENTION

To achieve the above objects, a printer according to the present invention has a housing that is substantially triangularly shaped in cross-section and comprises a roll paper stored proximally to the printer's center of gravity; an electrical connection unit located proximally to at least one corner of the housing corresponding to at least one vertex in the triangular shape (in cross-section); and an exit opening for the roll paper located proximally to at least one corner of the housing corresponding to at least one vertex of the triangular shape (in cross-section).

A printer thus comprised can be placed for use on at least two sides of this housing, each of these sides comprising a sitting surface of the printer.

A functional component of the printer is disposed proximally to at least one of the three corners of the housing corresponding to the three vertices of the triangular shape, and the locations of functional components are preferably distributed among all three corners of the housing corresponding to the vertices of the triangle.

Yet further preferably, the printer has a printer control unit disposed proximally to one of the three housing corners (vertices). Yet further preferably, the printer control unit is disposed near the printer's electrical connection unit.

Yet further preferably, the printer has a printer power supply unit disposed proximally to one of the three vertices of the triangular (in cross-section) housing.

The printer of the present invention achieves the following advantages.

(1) Access to the electrical connection unit of the printer is not hindered regardless of which sitting surface the printer is placed on for use. It is therefore easy to connect external cables to the electrical connection unit.

It is to be noted that “sitting surface” as used herein means the side of the printer that contacts the support surface, e.g. table or shelf top, on which the printer is placed for use. If rubber or other feet are provided on such side of the printer, the “sitting surface” refers to the plane containing the parts of such feet that contact the support surface on which the printer is placed.

(2) The printer can be placed in a number of stable positions.

(3) Roll paper can be efficiently stored inside the printer housing or case.

(4) The roll paper diameter can be increased until the roll contacts the inside of the printer housing. A large diameter roll of paper can therefore be used.

(5) The size of the printer can be reduced to match the diameter of the roll.

(6) The distance between the printer control unit and connections to external devices can be shortened. As a result, external noise and unwanted radiation noise can be reduced.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts:

FIG. 1 is an external view from the front of a printer according to a preferred embodiment of the present invention;

FIG. 2 is an external view from the back of the printer shown in FIG. 1;

FIG. 3A is a perspective view showing the printer in FIG. 1 when placed for use on the bottom, i.e. sitting surface 11b; FIG. 3B is a perspective view showing the printer in FIG. 1 when placed on the back, i.e. sitting surface 11c; and FIG. 3C is a perspective view showing the printer in FIG. 1 when placed on a side, i.e. sitting surface 11d;

FIG. 4A and FIG. 4B are side cross-sectional views of the printer shown in FIG. 1;

FIG. 5 is an enlarged, partial, side cross-sectional view of the interface cable connecting area;

FIG. 6 is an external view of a printer according to an alternative embodiment of the present invention;

FIG. 7 is a partially cut-away side view of the printer shown in FIG. 6; and

FIG. 8 is a view of the printer shown in FIG. 6, opened to show its internal configuration.

### DESCRIPTION OF THE PREFERRED EMBODIMENTS

A preferred embodiment of the present invention is described below with reference to the accompanying figures. It is to be noted that while this preferred embodiment of the invention is described as it applies to a POS printer, it will be obvious to one with ordinary skill in the related art that the present invention shall not be limited to a POS printer.

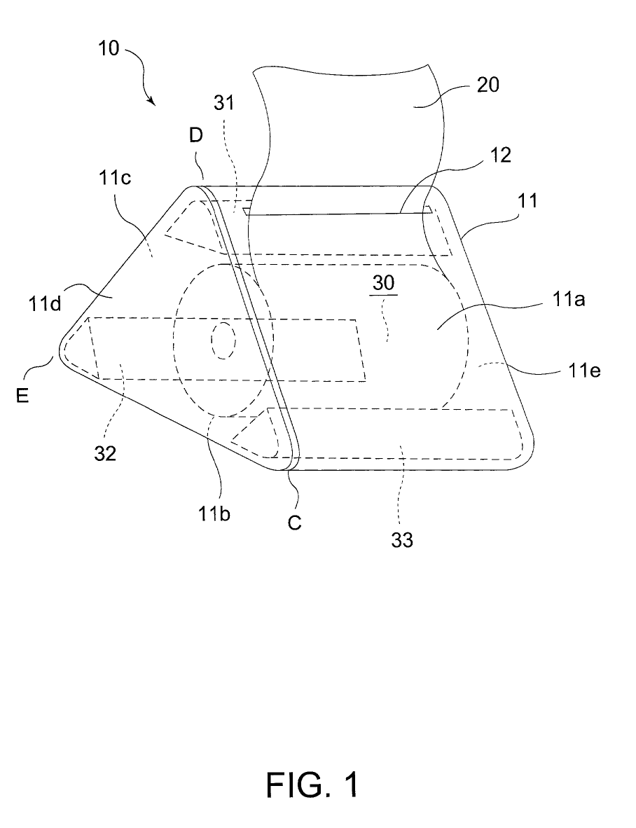

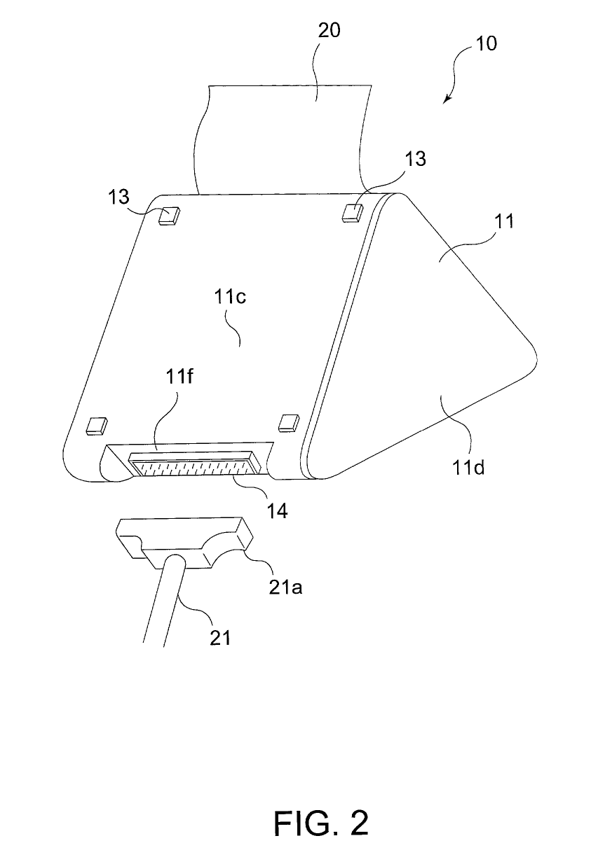

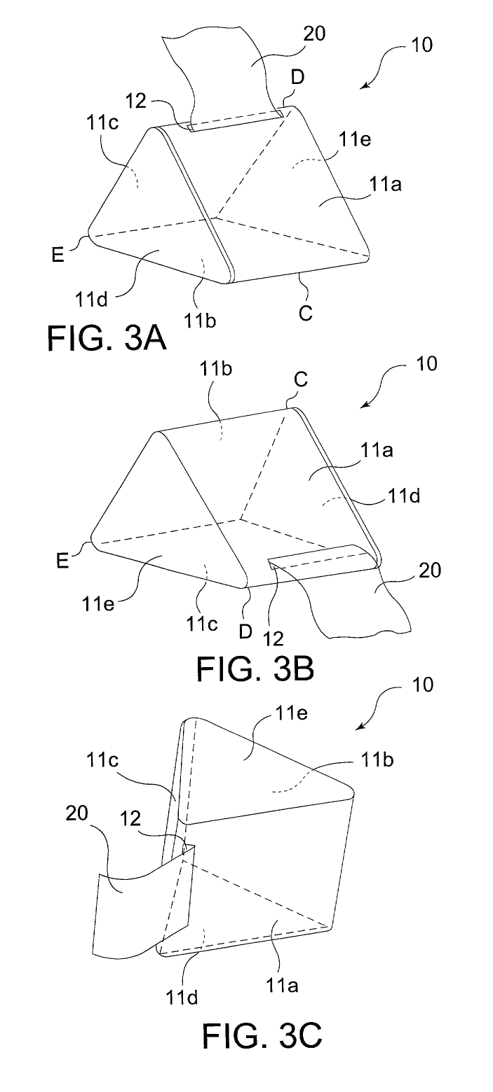

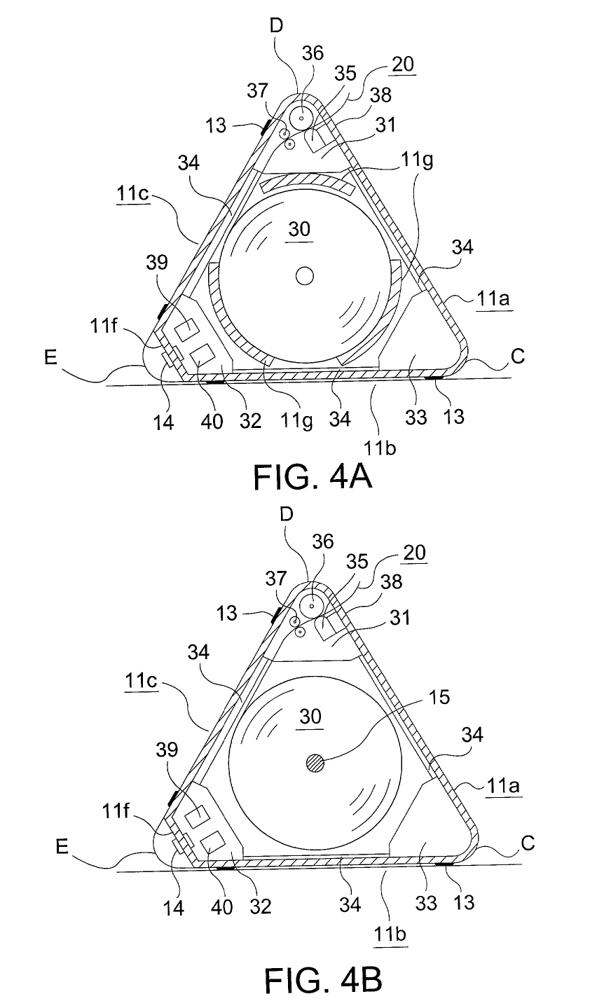

FIG. 1 is an external perspective view from the front of a printer according to a preferred embodiment of the invention. FIG. 2 is a similar view but from the back of the same printer. FIGS. 3A, 3B and 3C show various positions or orientations in which the printer can be placed for use. FIGS. 4A and 4B are side section view of the same printer. As will be obvious from these figures, an exemplary printer according to the present invention has a substantially triangular shape in cross-section or when viewed from the side. This printer can be used when placed on one of the sides forming the triangular shape or when stood on end.

More specifically, the housing 11 of this exemplary printer 10 shown in FIG. 1 has a front 11a, bottom 11b, back 11c, and two sides 11d and 11e.

A paper exit 12 is formed near the top of the housing front 11a. As described more fully below, roll paper 20 is housed inside the printer 10 as the printing paper supply, and one end of the roll is delivered out from the paper exit 12. The printer front 11a is the side typically installed facing the user. While not shown in the figures, various control buttons and LED indicators are usually provided on this front 11a for easy access by the user.

The printer 10 is typically installed resting on the bottom 11b, which is one sitting surface of the printer. Bottom 11b is provided at its four corners with feet 13, which are typically rubber. Feet 13 are similarly provided on the back 11c of the housing, and are also provided on one side 11d, each of which form additional sitting surfaces for the printer. This exemplary printer 10 can thus be placed on any of three sitting surfaces, that is, bottom 11b, back 11c and side 11d, and can be used for printing in any of these three orientations.

FIG. 3A shows the printer 10 when placed on bottom 11b; FIG. 3B shows the printer 10 placed on back 11c; and FIG. 3C shows the printer 10 placed on side 11d.

When placed on bottom 11b, the paper exit 12 is located near the top of the front 11a. When on back 11c, the paper exit 12 is near the bottom of front 11a. When the printer 10 is placed on side 11d, the paper exit 12 is on the side near the left end of the front 11a.

When a roll paper printer is used as a POS printer for printing receipts, for example, the paper exit 12 is typically at the top as shown in FIG. 3A. When used for stamping tickets at a parking lot entrance, for example, the paper exit 12 is typically oriented so that the roll paper (ticket) comes out from the bottom. It will thus be obvious that a printer according to this preferred embodiment of the invention can be easily installed in different positions or orientations according to the specific installation requirements dictated by the user's application of the printer.

The configuration of an interface cable connector in this exemplary printer 10 is described next. As shown in FIG. 2 and FIGS. 4A and 4B, the interface cable connector 14 is disposed at connector mounting surface 11f at the intersection of bottom 11b and back 11c. As shown in FIG. 2, this connector 14 mates with an interface cable 21 for sending and receiving data between the printer 10 and a host device, and is typically an RS-232C, Centronics, or other standardized connector. It is to be noted that in the example shown in FIG. 2 power is also supplied to the printer through the interface cable 21. It will also be obvious that a separate power cable connector could be provided on the same connector mounting surface 11f, or a power cable could be passed from inside the printer out through this connector mounting surface 11f.

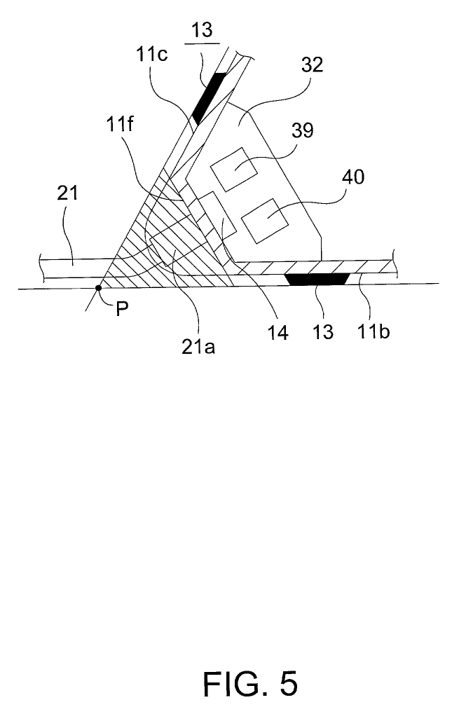

FIG. 5 is an enlarged, side, cross-sectional view of this interface cable connector area. As shown in the figure, the connector mounting surface 11f is formed at a position sufficiently recessed from the point of intersection P of lines extended parallel to the feet 13 on the bottom 11b and the feet 13 on the back 11c of the printer 10. More specifically, the connector mounting surface 11f is recessed from intersection P enough to permit the connector 21a on the end of the interface cable 21 to fit within the area (shown as shaded or hatched) between the connector mounting surface 11f and these lines extended from the feet 13 on front and back sides of the printer.

By thus disposing the connector mounting surface 11f, the connector 14 remains accessible at the back of the printer 10 so that the interface cable 21 can be connected with the printer 10 resting on either bottom 11b or back 11c. More specifically, when the interface cable 21 is connected to the printer 10 and the printer 10 is placed on a desk or similar surface, the connector 21a will not contact the top of the support surface on which the printer 10 is placed, and poor connector contact caused by the weight of the printer is avoided because the weight of the printer does not bear on the connector 21a.

The internal configuration of this exemplary printer 10 is described next with reference to FIGS. 4A and 4B. Inside housing 11, printer 10 has a roll paper compartment 30, printing mechanism unit 31, control unit 32, and power supply unit 33. The roll paper compartment 30 is in the middle of the housing 11. As shown in FIG. 4A, roll paper 20 is stored inside three walls 11g, which form part of a circle, with the three sides of a triangle formed by the front 11a, bottom 11b, and back 11c of the printer 10 being substantially tangent to the circle. Two of these three walls 11g rotatably support the roll paper 20, whether the printer 10 is placed on bottom 11b or back 11c. The walls 11g are preferably formed of PTFE (polytetrafluoroethylene) or other material with a similarly low coefficient of friction. It is alternatively possible to provide roller bearings or other mechanical support for further reducing friction with the roll paper 20.

As shown in FIGS. 4A and 4B, the printer 10 has a substantially triangular shape in cross-section when viewed from the side, and has three vertices, or corners, at C, D, and E. Corner or vertex C is at the intersection of front 11a and bottom 11b; corner or vertex D is between front 11a and back 11c; and corner or vertex E is between bottom 11b and back 11c. Roll paper 20 is stored in the roll paper compartment 30, which is formed proximally to the center of gravity of the triangle-shaped housing 11.

Roll paper 20 is fed through printing mechanism unit 31 that is disposed proximally to corner or vertex D. Control unit 32 is disposed proximally to corner or vertex E and is provided with connector 14 for connecting a cable from an external device (see FIG. 5). The power supply unit 33 is disposed proximally to corner or vertex C, where further provision is made for passing a power cable (not shown) out from inside the printer. Each of printing mechanism unit 31, control unit 32, and power supply unit 33 is an example of functional components of printer 10.

Corners C, D and E are preferably rounded and therefore offset to the inside from the points of intersection of planes extended along sides 11a, 11b, and 11c. By thus disposing the paper exit and cable connectors at the corners, the paper exit and cable connections will be above the sitting surface (e.g. bottom 11b in FIG. 4A) on which the printer is placed for use. This simplifies connection of cables and removal of roll paper from the paper exit.

Alternatively, as shown in FIG. 4 B, it is possible to dispose a roll paper spindle 15 in the center of the triangularly shaped housing 11, rather than providing walls 11g. In this case, the spindle 15 passes through the core of roll paper 20, which then rolls on the spindle 15. In this case roll paper can be stably supported inside the printer 10 regardless of the roll paper diameter, and the roll paper will not be damaged by changing the position of the printer (e.g., as shown in FIGS. 3A to 3B) with paper loaded inside. Using a spindle 15 also reduces the rolling resistance of the roll paper 20.

Roll paper 20 is loaded and replaced from one side of the printer by providing an opening in one side 11e of the housing 11. Various methods can be used for opening the housing 11 from one side wall. For example, the side wall can pivot around a single pivot point disposed at one corner C, D, or E, or the side wall can hinge along any of its three sides. It is to be noted that if a roll paper spindle is used as the roll paper support, a bearing supporting the spindle is preferably disposed in the side wall.

The printing mechanism unit 31, control unit 32, and power supply unit 33 are disposed outside walls 11g, that is, in the spaces near the corners C, D, and E. More specifically, in the exemplary printer 10 shown in FIGS. 4A and 4B, the printing mechanism unit 31 is in corner D between front 11a and back 11c; control unit 32 is in corner E between bottom 11b and back 11c; and power supply unit 33 is in corner C between front 11a and bottom 11b. These units 31 to 33 are interconnected by means of flat cable 34 disposed along walls 11a to 11c of housing 11.

The printing mechanism unit 31 prints on the leading end of the roll paper 20 with a thermal print head 35, a platen 36, roll paper guide 37, and paper cutter 38. It is to be noted that the platen 36 also functions as a paper feed roller. The leading end of the roll paper 20 is fed between two walls 11g to the printing mechanism unit 31, passes from the roll paper guide 37 through the gap between thermal print head 35 and platen 36, and exits from the paper exit 12. While not shown in the figures, the printing mechanism unit 31 can further comprise other components necessary for printing, including a drive mechanism for the roll paper guide 37 and a print head moving unit.

It is to be further noted that the roll paper guide 37 can also function as a feed roller for reducing variations in the paper transport speed resulting from variations in paper-related loads, including friction and the inertial mass of the roll paper itself.

The control unit 32 is disposed on the back of the connector mounting surface 11f, and comprises a control unit circuit board that includes such electrical and electronic components as connector 14, control CPU 39, and memory 40. The control unit 32 thus controls the printing mechanism unit 31 and communicates with the host computer via interface cable 21.

The power supply unit 33 includes a circuit board comprising the power supply circuit and other related circuitry.

By thus placing the roll paper compartment 30, printing mechanism unit 31, control unit 32, and power supply unit 33 in a triangular housing 11, it is possible to house all components essential to printer operation internally in a printer with an extremely small footprint. It is therefore possible to achieve, according to the present invention, a printer that can be placed in a number of orientations for installation and use while at the same time achieving a compact printer with an extremely small printer footprint.

It will also be obvious to one with ordinary skill in the related art that the locations of the control unit 32 and power supply unit 33 can be switched. If power is externally supplied to the control unit, it is also possible to omit the power supply unit 33.

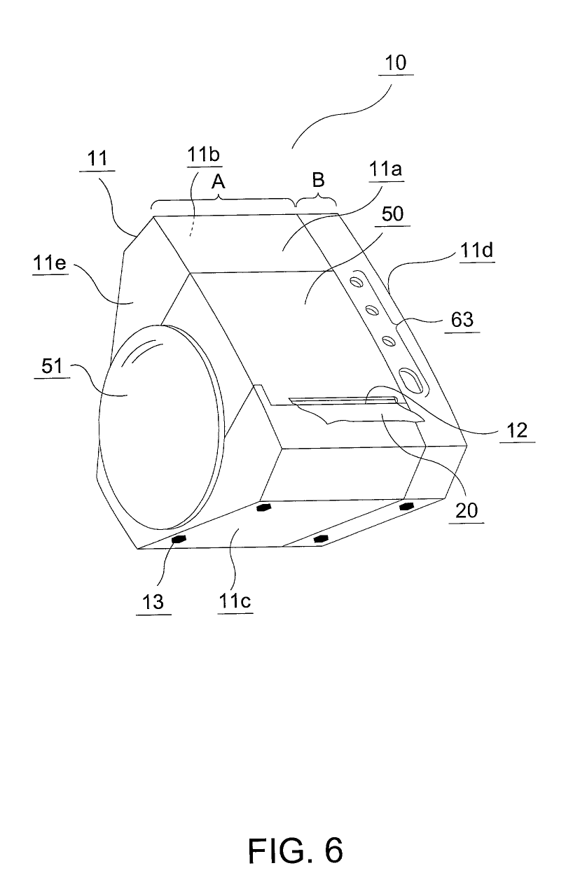

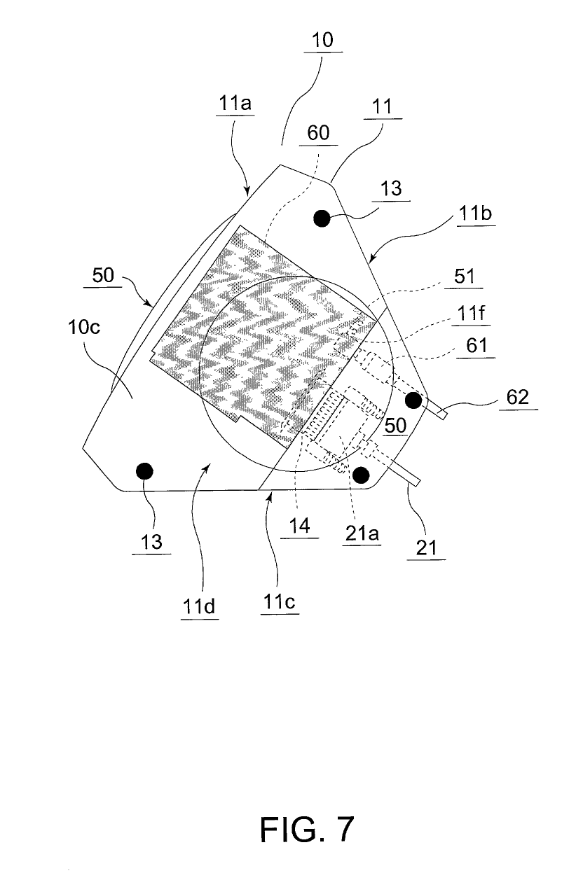

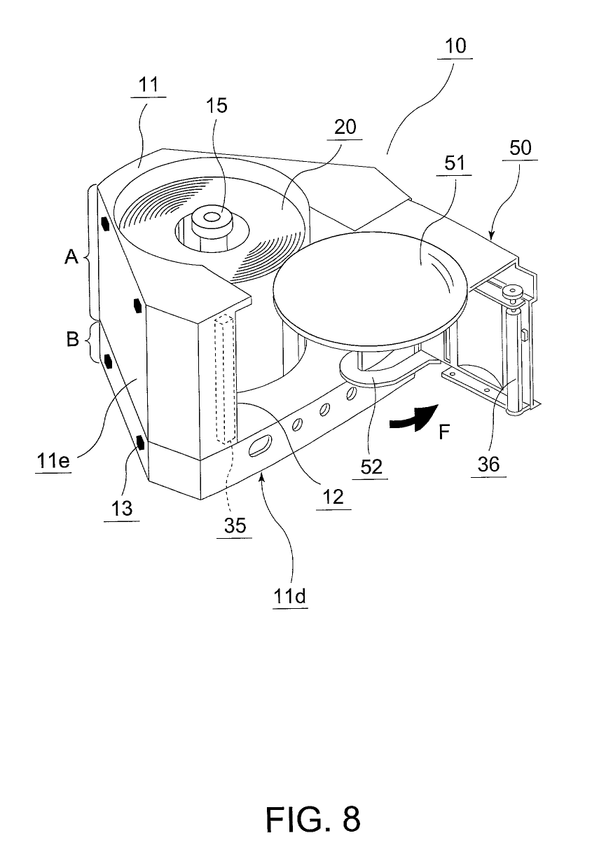

Alternative configurations of a printer according to the present invention are shown in FIGS. 6, 7, and 8. FIG. 6 is an external view of a printer placed on back 11c, and FIG. 7 is a right side view of the printer shown in FIG. 6. FIG. 8 is an external view showing the internal configuration of a printer placed on side 11d.

FIGS. 6, 7, and 8 show printer 10, housing 11, front 11a with control functions, and sides 11d and 11e. Bottom 11b as seen in FIG. 1 becomes the back 11b in FIGS. 6 to 8. Back 11c as seen in FIG. 1 becomes the bottom 11c in FIGS. 6 to 8. Also shown are the paper exit 12, feet 13, and roll paper 20. As noted above, the feet 13 are typically rubber. Control cover 50 forms part of front 11a and is integrated with paper compartment cover 51. The control cover 50 can be opened in the direction of the arrow F, shown in FIG. 8, to replace and load roll paper.

The roll paper 20 is supported on spindle 15. After placing the roll paper 20 on spindle 15, the end of roll paper 20 is passed out through paper exit 12, and the control cover 50 is then closed in the direction opposite the arrow F in FIG. 8 to close the compartment and enable printing. The thermal print head 35 and platen 36 of the printing unit are also shown in FIG. 8.

Included in the roll paper storage area A, shown in FIG. 6, are the thermal print head 35, platen 36 of the printing unit, and roll paper 20. Included in control unit area B are circuit board 60, connector mounting surface 11f, connector 14, LEDs and switches 63, interface cable 21, power supply connector 61, and power supply cable 62.

As shown in FIG. 7, the connector mounting surface 11f for interface cable connection is disposed at a position sufficiently recessed from the intersection of lines extended from back 11c and bottom 11b. The size of this recess is large enough so that the connector 21a of interface cable 21 and the power supply connector 61 can fit inside the space formed between the connector mounting surface 11f and the intersection of lines extended from bottom 11c and back 11b. It is therefore possible to connect interface cable 21 to the printer while retaining the ability to place and use the printer on any of sides 11b, 11c, and 11d.

As described above, a printer according to the present invention can be placed and used on any of three sides (sitting surfaces) while maintaining access to the external connections. It is therefore possible to easily connect external cables to the electrical connectors of the printer regardless of which surfaces the printer is placed on. A printer according to the present invention can therefore be easily adapted to different applications requiring the printed roll paper to exit from the top, bottom, or side of the printer.

It is also possible with a printer according to the present invention to store heavy roll paper in the center of the printer. It is therefore also possible to provide a printer with good stability and balance.

It is yet further possible with the present invention to provide a printer that stores roll paper inside the printer and is significantly smaller than a conventional printer that internally stores roll paper.

Although the present invention has been described in connection with the preferred embodiments thereof with reference to the accompanying drawings, it is to be noted that various changes and modifications will be apparent to those skilled in the art.

For example, it is alternatively possible to provide the paper exit 12 at corner D between front 11a and back 11c with the control buttons and other components disposed on 11d or 11e rather than provided on the front 11a. In this case, 11d or 11e is also used as the cover 50 for the roll paper compartment, and platen 36 can be separated from the print head 35 when the cover 11d or 11e is open. Also in this case, the printer can be set down on front 11a for use.

It will also be obvious that while the present invention has been described with reference to a printer with sides that form a triangle, the present invention shall also include other polygonally shaped (in cross-section) printer housings.

While the invention has been described in conjunction with several specific embodiments, it is evident to those skilled in the art that many further alternatives, modifications and variations will be apparent in light of the foregoing description. Thus, the invention described herein is intended to embrace all such alternatives, modifications, applications and variations as may fall within the spirit and scope of the appended claims.

What is claimed is:

1. A printer having a center of gravity and a substantially triangular shape in cross-section, and comprising:
a housing with three sides forming said substantially triangular shape;
roll paper stored in said housing proximally to said center of gravity;
an electrical connection unit located in said housing proximally to at least one vertex of said sides forming said triangular shape; and
an exit opening in said housing for said roll paper located proximally to at least one vertex of said sides forming said triangular shape.

2. The printer as set forth in claim 1, wherein at least two of said three sides forming said triangular shape are alternative sitting surfaces on which said printer rests in use.

3. The printer as set forth in claim 1, further comprising a functional component disposed proximally to at least one of three vertices of said sides forming said triangular shape.

4. The printer as set forth in claim 1, further comprising a printer control unit disposed proximally to one of three vertices of said sides forming said triangular shape.

5. The printer as set forth in claim 4, wherein said printer control unit is disposed near said electrical connection unit.

6. The printer as set forth in claim 1, further comprising a printer power supply unit disposed proximally to one of three vertices of said sides forming said triangular shape.

7. A printer with a housing having a substantially triangular shape in section, and comprising:
a roll of paper arranged inside said housing;
an electrical connector unit provided proximal to one of the vertices of said triangle; and
an electrical connector unit provided proximal to one of the vertices of said triangle on a plane that intersects the two sides of the housing forming that vertex; and
a paper exit opening provided at or proximal to one of the vertices of said triangle.
